(19) United States
(12) Patent Application Publication
(10) Pub. No.: US 2003/0152718 A1
(43) Pub. Date: Aug. 14, 2003

(54) Polarizing plate and optical member

(76) Inventors: Eiji Hamamoto, Osaka (JP); Youichirou Sugino, Osaka (JP); Seiichi Kusumoto, Osaka (JP); Takashi Shouda, Osaka (JP)

Correspondence Address: ARMSTRONG,WESTERMAN & HATTORI, LLP, 1725 K STREET, NW, SUITE 1000, WASHINGTON, DC, 20006, US

(21) Appl. No.: 10/071,301

(22) Filed: Feb. 8, 2002

(51) Int. Cl. C09K 19/00

(52) U.S. Cl. 428/1.31; 428/343

(57) ABSTRACT

A durable polarizing plate having a transparent protective film that is difficult to peel off under an influence of humidity and heat is disclosed. Such a polarizing plate is provided by bonding a transparent protective film through an adhesive layer on at least one surface of a polyvinyl alcohol-based polarizing film containing a dichroic substance, and the adhesive layer includes a water-soluble crosslinking agent that can crosslink a vinyl alcohol-based polymer. The adhesive layer can further include a vinyl alcohol-based polymer.

### BACKGROUND OF THE INVENTION

1. Field of the Invention

The present invention relates to a polyvinyl alcohol-based polarizing plate with excellent durability and an optical member using the same.

2. Description of the Related Art

A conventionally-used polarizing plate comprises a polarizing film of polyvinyl alcohol containing a dichroic substance, and a transparent protective film is bonded to at least one surface of the polarizing film through an adhesive layer comprising polyvinyl alcohol. However, such a polarizing plate has a poor durability since the transparent protective film peels off under an influence of humidity or heat.

### SUMMARY OF THE INVENTION

Improvement of durability of polarizing plates is an urgent matter for liquid crystal displays since use of the liquid crystal displays under severe conditions is increased with the increasing range of uses. In view of this, the present invention provides a polarizing plate with excellent durability, and the polarizing plate comprises a transparent protective film that is difficult to peel off under an influence of humidity or heat.

For the above purpose, the present invention provides a polarizing plate made by bonding a transparent protective film through an adhesive layer on at least one surface of a polyvinyl alcohol-based polarizing film containing a dichroic substance, and the adhesive layer comprises a water-soluble crosslinking agent that can crosslink a vinyl alcohol-based polymer.

In one preferred embodiment, the adhesive layer contains further a vinyl alcohol-based polymer.

In one preferred embodiment, the water-soluble crosslinking agent is selected from the group consisting of boric acid, borax, glutaraldehyde, melamine and oxalic acid.

In one preferred embodiment, the transparent protective film comprises a polymer selected from the group consisting of an acetate-based resin, a polyester-based resin, a polyethersulfone-based resin, a polycarbonate-based resin, a polyamide-based resin, a polyimide-based resin, a polyolefine-based resin and an acrylic resin. A most preferred transparent protective film is a triacetylcellulose film having a saponified surface.

The present invention provides an optical member of a laminate made by providing at least one additional optical layer on a polarizing plate comprising a polyvinyl alcohol-based polarizing film containing a dichroic substance and also a transparent protective film bonded to at least one surface of the polyvinyl alcohol-based polarizing film through an adhesive layer, where the adhesive layer comprises a water-soluble crosslinking agent with ability of crosslinking a vinyl alcohol-based polymer, and the additional optical layer is other than a polarizing layer.

In one preferred embodiment, the optical layer is at least one selected from the group consisting of a reflective layer, a semitransparent reflective layer, a brightness-enhanced plate and retardation plate.

### DETAILED DESCRIPTION OF THE INVENTION

A polarizing plate according to the present invention is provided by bonding a transparent protective film on at least one surface of a polyvinyl alcohol-based polarizing film containing a dichroic substance through an adhesive layer comprising a water-soluble crosslinking agent that can crosslink a vinyl alcohol-based polymer.

A polarizing film can be made of any appropriate conventional vinyl alcohol-based polymers, such as polyvinyl alcohol and partially-formalized polyvinyl alcohol. Such a film is subjected to treatments such as stretching, crosslinking and dyeing with a dichroic substance comprising a dichroic dyestuff and iodine in any proper order and proper manner so as to provide a film that will transmit linearly polarized light when natural light enters. It is preferred to obtain a film having excellent light transmittance and polarization property. Atypical polarizing film has a thickness ranging from 5 μm to 80 μm though the range is not limitative.

The transparent protective film provided to at least one surface of the polarizing film can be selected properly. Preferred films are made of polymers having excellent transparency, mechanical strength, thermal stability, and water shielding property. Examples of such polymers include acetate-based resins such as triacetylcellulose, polyester-based resins, polyethersulfone-based resins, polycarbonate-based resins, polyamide-based resins, polyimide-based resins, polyolefine-based resins, acrylic resins or the like. A transparent protective film that is preferred particularly in an aspect of the characteristics such as polarization and durability is a triacetylcellulose film having a surface saponified with alkalis.

Though there is no specific limitation on the thickness of the transparent protective film, it is in general 500 μm or less, preferably in a range from 5 μm to 300 μm, most preferably, from 5 μm to 150 μm. When transparent protective films are provided onto both surfaces of a polarizing film, the polymer compositions of the protective films can be different from each other.

The transparent protective film can be subject to a hard-coat treatment, an antireflection treatment, an anti-sticking treatment, a diffusion treatment, and an anti-glare treatment. The hard-coat treatment is performed for, e.g., preventing scratches on the surface of the polarizing plate. A hard coat having excellent hardness and smoothness is made of an ultraviolet-curable resin based on silicone, urethane, acrylics or epoxy, and the coating is applied to the surface of the transparent protective film.

An anti-reflection treatment is performed by forming an antireflection film to suppress reflection of outdoor light on the surface of the polarizing plate. An anti-sticking treatment is performed to suppress sticking to the adjacent layers. An anti-glare treatment is performed to suppress glare, i.e., a phenomenon that outdoor daylight is reflected on a surface of a polarizing plate and the light will inhibit visibility of light passing through the polarizing plate, and the treatment includes formation of fine irregularity on a surface of a transparent protective layer by a proper method, such as roughening like sandblasting and embossing. Alternatively, transparent fine particles can be blended.

The transparent fine particles having an average particle diameter ranging from 0.5 μm to 20 μm can be selected from conductive/nonconductive inorganic fine particles such as silica, alumina, titania, zirconia, stannic oxide, indium oxide, cadmium oxide or antimony oxide, and organic fine particles such as crosslinked/uncrosslinked polymers. The amount of the fine particles is generally in a range from 2 weight parts to 70 weight parts for 100 weight parts of a resin, and particularly, it is in a range from 5 weight part to 50 weight part.

An anti-glare layer containing the above-mentioned transparent fine particles can be provided as a transparent protective layer or as a coating on a surface of another transparent protective layer. Alternatively, the anti-glare layer can function as a diffusion layer to diffuse light passing through the polarizing plate and to compensate the viewing angle. The above-described antireflective layer, an anti-sticking layer, a diffusion layer, and an anti-glare layer can be provided as a laminate sheet separately from the transparent protective film.

In forming a polarizing plate of the present invention, the polarizing film and the transparent protective film are bonded to each other through an adhesive layer comprising a water-soluble crosslinking agent that can crosslink a vinyl alcohol-based layer. Examples of water-soluble crosslinking agents include boric acid, borax, glutaraldehyde, melamine, and oxalic acid. A water-soluble crosslinking agent of the present invention serves to suppress peeling of the transparent protective film from the polarizing film under an influence of humidity or heat, and thus, a polarizing plate with excellent light transmittance and polarization property can be obtained. The adhesive layer can be formed by applying an aqueous solution containing at least one kind of water-soluble crosslinking agent and drying the applied solution. For example, an adhesive layer is formed in a process comprising: preparing an aqueous solution containing 0.1-10 wt % of a water-soluble crosslinking agent; applying the solution on a surface (preferably, the both surfaces) of a polarizing film; and bonding a transparent protective film on the polarizing film and drying at a temperature ranging from 30° C. to 100° C. The adhesive layer is in general from 0.02 μm to 0.5 μm in thickness.

Alternatively, a vinyl alcohol-based polymer can be used for a preparation of an aqueous solution containing such a water-soluble crosslinking agent. Examples of the vinyl alcohol-based polymers include polyvinyl alcohol and partially formalized polyvinyl alcohol. A preferable vinyl alcohol-based polymer has a polymerization degree ranging from 1000 to 6000 in an aspect of solubility and adhesiveness. When a water-soluble crosslinking agent and a vinyl alcohol-based polymer are used together, a preferable ratio is: water-soluble crosslinking agent/vinyl alcohol-based polymer=0.1-1.0 by weight. A catalyst such as an acid can be blended in the aqueous solution containing the water-soluble crosslinking agent.

A polarizing plate according to the present invention can compose a laminate with other optical layers and the laminate can be used as an optical member. There is no specific limitation on the optical layer(s). At least one proper optical layer other than a polarizing plate, e.g., a reflective layer, a semitransparent reflective layer, a brightness-enhanced plate and a retardation plate can be used as long as it is available for forming a liquid crystal display or the like.

The reflective layer is provided to a polarizing plate for forming a reflection type polarizing plate. The reflection type polarizing plate is used for a liquid crystal display that reflects incident light from the visible side (display side) for displaying. A liquid crystal display provided with the reflection type polarizing plate can be made thin, since an internal light source such as a backlight can be omitted.

A reflection type polarizing plate can be formed, for example, by attaching a reflective layer of metals etc. on a surface of a polarizing plate through a transparent protective film as required. Specifically, a reflective layer can be formed by attaching a foil or an evaporated film of a reflective metal such as aluminum on a surface of a transparent protective film that is subjected previously as required to a matting treatment.

Alternatively, a reflection type polarizing plate can comprise a transparent protective film containing fine particles to have a finely irregular surface and a reflective layer that is provided on the transparent protective film so as to correspond with the finely irregular surface. A reflective layer having a finely irregular surface can diffuse incident light so as to prevent orientation or glare and suppress contrast in brightness. Such a reflective layer of a finely irregular structure can be provided by applying a metal directly to the surface of a transparent protective film by any of suitable methods such as deposition and plating, i.e., vacuum deposition, ion plating and sputtering.

The reflective layer can be applied directly to a transparent protective film of a polarizing plate, or to any proper film similar to the transparent protective film. It is preferable that the reflective surface of the reflective layer is covered with a film, a polarizing plate or the like in use, since decrease in reflection that is caused by oxidation can be prevented and thus, the initial reflection rate can be maintained for a long time. Moreover, there is no need to apply a separate protective layer. The semitransparent polarizing plate can be obtained as a semitransparent reflective layer such as a half mirror that reflects and transmits light on the reflecting layer.

When natural light enters a brightness-enhanced plate, the plate reflects linearly polarized light of a predetermined polarization axis or circularly polarized light in a predetermined direction while transmitting the remaining light. The brightness-enhanced plate is laminated with a polarizing plate to provide a polarized-light splitter polarizing plate. The splitter polarizing plate allows entrance of light from a light source such as a backlight so as to obtain transmitted light in a predetermined polarization state, while reversing reflected light through a reflective layer etc. for re-entering the brightness-enhanced plate so that at least one part of the reflected light passes as light of a predetermined polarization state so as to increase the amount of light passing the brightness-enhanced plate. As a result, quantity of light available for the liquid crystal display can be increased to improve brightness.

A suitable example of the brightness-enhanced plate is selected from a multilayer thin film of a dielectric or a multilayer lamination of thin films with varied refraction aeolotropy (e.g., “D-BEF” supplied by 3M Co.) that transmits linearly polarized light having a predetermined polarization axis while reflecting other light, and a cholesteric liquid crystal layer, more specifically, an oriented film of a cholesteric liquid crystal polymer or an oriented liquid crystal layer fixed onto a supportive substrate (e.g., “PCF 350” supplied by Nitto Denko Corporation; “Transmax” supplied by Merck and Co., Inc.) that reflects either clockwise or counterclockwise circularly polarized light while transmitting other light.

Therefore, for a brightness-enhanced plate to transmit linearly polarized light having a predetermined polarization axis, the transmission light enters the polarizing plate by matching the polarization axis so that absorption loss due to the polarizing plate is controlled and the light can be transmitted efficiently. For a brightness-enhanced plate to transmit circularly polarized light, i.e., a cholesteric liquid crystal layer, preferably, the circularly polarized light is converted to linearly polarized light before entering the polarizing plate in an aspect of controlling of the absorption loss, though the circularly polarized light can enter the polarizing plate directly. Circularly polarized light can be converted to linearly polarized light by using a quarter wavelength plate for a retardation plate.

A retardation plate having a function as a quarter wavelength plate in a wide wave range including a visible light region can be obtained, for example, by overlapping a retardation layer functioning as a quarter wavelength plate for monochromatic light such as light having 550 nm wavelength and another retardation plate showing a separate optical retardation property (e.g., a retardation plate functioning as a half wavelength plate). Therefore, a retardation plate arranged between a polarizing plate and a brightness-enhanced film can comprise a single layer or at least two layers of retardation layers.

A cholesteric liquid crystal layer also can be provided by combining layers different in the reflection wavelength and it can be configured by overlapping two or at least three layers. As a result, the obtained retardation plate can reflect circularly polarized light in a wide wavelength range including a visible light region, and this can provide transmission circularly polarized light in a wide wavelength range.

The above-described retardation plate is selected arbitrarily from various retardation plates such as a quarter wavelength plate and a half wavelength plate, or any plates for compensating coloring caused by birefringence of the liquid crystal layer and compensating for visual angle including enlargement of the visual angle. It can be an inclined orientation film with controlled refractive index in the thickness direction. Alternatively, at least two kinds of retardation plates can be laminated to control optical properties such as phase difference. Therefore, a laminate of a polarizing plate and a retardation plate is not limited to an elliptically polarizing plate.

Specific examples of the retardation plates include birefringent films, oriented films of liquid crystal polymers, and sheets comprising film and oriented layers supported by the films. The birefringent films can be prepared by stretching films of any suitable polymers such as polycarbonate, polyvinyl alcohol, polystyrene, polymethyl methacrylate, polyolefins including polypropylene, polyalylate, polyamide and polynorbornene. An incline-oriented film is produced, for example, by bonding a heat shrinkable film onto a polymer film and stretching and/or shrinking the polymer film under an influence of the shrinking force provided by heat, or by orienting obliquely a liquid crystal polymer.

An optical member can be a laminate of a polarizing plate and two or more optical layers. An example thereof is a polarized-light splitter polarizing plate. Alternatively, the above-mentioned reflection type polarizing plate or the semitransparent polarizing plate can be combined with a retardation plate in order to provide a reflection type elliptically polarizing plate or a semitransparent elliptically polarizing plate. An optical member comprising a laminate of two or more optical layers can be formed separately in a predetermined order during a process for manufacturing a device such as a liquid crystal display. When such optical layers are laminated prior to the manufacturing process, excellent stability in the quality and work efficiency in the fabrication are obtained, and efficiency in manufacturing a liquid crystal display can be improved. Any proper adhesive means such as pressure-sensitive adhesive layers can be used for the lamination.

A pressure-sensitive adhesive layer can be provided to a polarizing plate or to an optical member according to the present invention in order to adhere to other members such as a liquid crystal cell. The pressure-sensitive adhesive layer can be formed from a known adhesive based on acrylic substances. It should be noted that the pressure-sensitive adhesive layer preferably has a low coefficient of humidity absorption and excellent thermal resistance so as to prevent foaming or peeling caused by humidity absorption and to prevent decrease in optical characteristics and warping of the liquid crystal cells caused by thermal expansion difference, so that a liquid crystal device with high quality and durability can be obtained. The pressure-sensitive adhesive layer can include fine particles so as to have a light diffusion property.

When a pressure-sensitive adhesive layer is exposed on a surface of the polarizing plate or the optical member, preferably, the pressure-sensitive adhesive layer is covered with a separator by the time the pressure-sensitive adhesive layer is used so that contamination will be prevented. The separator can be made of an appropriate thin sheet similar to a transparent protective film by coating a peeling agent if required, and the peeling agent may be selected, for example, from a silicone-based agent, a long-chain alkyl-based agent, a fluorine-based agent, an agent comprising molybdenum sulfide or the like.

The above-described members composing a polarizing plate and an optical member, such as a polarizing film, a transparent protective film, an optical layer and a pressure-sensitive adhesive layer, can have ultraviolet absorption power as a result of treatment with an ultraviolet absorber such as an ester salicylate compound, a benzophenone compound, a benzotriazole compound, a cyanoacrylate compound, and a nickel complex salt compound.

Polarizing plates according to the present invention can be used preferably for forming various devices such as liquid crystal displays. Such a polarizing plate and an optical member are arranged on at least one surface of a liquid crystal cell in order to form various devices such as a liquid crystal display. The liquid crystal display is selected from devices of conventionally known structures, such as transmission type, reflection type, or a transmission-reflection type. A liquid crystal cell to compose the liquid crystal display can be selected from appropriate cells of such as active matrix driving type represented by a thin film transistor, a simple matrix driving type represented by a twist nematic type and a super twist nematic type.

When polarizing plates or optical members are arranged on both surfaces of a liquid crystal cell, the polarizing plates or the optical members on the surfaces can be the same or can be varied. Moreover, for forming a liquid crystal display, one or at least two layers of appropriate members such as a prism array sheet, a lens array sheet, an optical diffuser and a backlight can be arranged at proper positions.

The present invention will be described below more specifically by referring to the following Examples and Comparative Example.

### EXAMPLE 1

Along polyvinyl alcohol film 75 μm in thickness was dipped in a dye bath (30° C.) containing a blend of iodine and potassium iodide while being conveyed continuously by means of a guide roller in order to perform dyeing and stretching to 3 times its original length. Subsequently, the film was stretched to 6 times its original length and crosslinked in an acid bath (60° C.) containing boric acid and potassium iodide. The film was then dried for 7 minutes at 50° C. so that a polarizing film 29 μm in thickness was obtained. On both the surfaces, an adhesive that was prepared from a 1.5 wt % aqueous solution of glutaraldehyde where the pH was controlled to 2 with hydrochloric acid was applied. A triacetylcellulose film being 80 μm in thickness and having a surface saponified with an aqueous solution of sodium hydroxide was bonded to the polyvinyl alcohol film applied with the adhesive before drying at 80° C. so that a polarizing plate 189 μm in thickness was obtained.

### EXAMPLE 2

A polarizing plate 189 μm in thickness was obtained in accordance with Example 1 except that the adhesive was prepared by adding glutaraldehyde to a 7 wt % aqueous solution of polyvinyl alcohol to obtain a concentration of 1.5 wt %, whose pH was controlled to 2 by means of hydrochloric acid. The polyvinyl alcohol in Example 2 was GOHSENOL (trade name) supplied by the Nippon Synthetic Chemical Industry Co., Ltd.

### Comparative Example 1

A polarizing plate 189 μm in thickness was obtained in accordance with Example 1 except that the adhesive was a 7 wt % aqueous solution of polyvinyl alcohol. The polyvinyl alcohol was identical to that of Example 2.

### Evaluation

Light transmittance and polarization property were evaluated for the polarizing plates obtained in Examples 1, 2 and Comparative Example 1. Specimens of 10 cm×10 cm prepared respectively for the Examples and Comparative Example were dipped in a 60° C. water for two hours. The specimens were taken out from the water to check peeling of the polarizing films and triacetylcellulose films. The results are shown in table 1.

TABLE 1

| | | | Comparative |
|---|---|---|---|
| | Example 1 | Example 2 | Example 1 |
| Light transmittance (%) | 43.8 | 43.8 | 43.8 |
| Polarization property (%) | 99.95 | 99.95 | 99.95 |
| Peeling | No | No | Yes |

As shown in Table 1, a polarizing plate provided by bonding a polarizing film and a transparent protective film through an adhesive layer comprising a water-soluble crosslinking agent according to the present invention has excellent light transmittance and polarization property, and also high durability. In other words, the polarizing film and the transparent protective film are hard to peel under an influence of humidity and heat.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, all changes that come within the meaning and range of equivalency of the claims are intended to be embraced therein.

What is claimed is:

1. A polarizing plate comprising a polyvinyl alcohol-based polarizing film containing a dichroic substance and a transparent protective film bonded to at least one surface of the polyvinyl alcohol-based polarizing film through an adhesive layer, wherein
the adhesive layer comprises a water-soluble crosslinking agent capable of crosslinking a vinyl alcohol-based polymer.

2. The polarizing plate according to claim 1, wherein the adhesive layer further comprises the vinyl alcohol-based polymer.

3. The polarizing plate according to claim 1, wherein the water-soluble crosslinking agent is selected from the group consisting of boric acid, borax, glutaraldehyde, melamine and oxalic acid.

4. The polarizing plate according to claim 1, wherein the transparent protective film comprises a polymer selected from the group consisting of an acetate-based resin, a polyester-based resin, a polyethersulfone-based resin, a polycarbonate-based resin, a polyamide-based resin, a polyimide-based resin, a polyolefine-based resin and an acrylic resin.

5. The polarizing plate according to claim 1, wherein the transparent protective film is a triacetylcellulose film having a saponified surface.

6. An optical member of a laminate made by providing at least one additional optical layer on a polarizing plate comprising a polyvinyl alcohol-based polarizing film containing a dichroic substance and a transparent protective film bonded to at least one surface of the polyvinyl alcohol-based polarizing film through an adhesive layer, wherein the adhesive layer comprises a water-soluble crosslinking agent capable of crosslinking a vinyl alcohol-based polymer, and wherein the additional optical layer is other than a polarizing layer.

7. The optical member according to claim 6, wherein the additional optical layer is at least one selected from the group consisting of a reflective layer, a semitransparent reflective layer, a brightness-enhanced plate and a retardation plate.

8. A liquid crystal display comprising a liquid crystal cell and a polarizing plate arranged on at least one surface of the liquid crystal cell, wherein the polarizing plate comprises a polyvinyl alcohol-based polarizing film containing a dichroic substance and a transparent protective film bonded to at least one surface of the polyvinyl alcohol-based polarizing film through an adhesive layer, where the adhesive layer comprises a water-soluble crosslinking agent capable of crosslinking a vinyl alcohol-based polymer.
